(19) United States
(12) Patent Application Publication
(10) Pub. No.: US 2010/0295763 A1
(43) Pub. Date: Nov. 25, 2010

(54) IMAGE PROCESSING DEVICE AND METHOD THEREOF

(75) Inventors: Huang-Min Chen, Changhua County (TW); Kuang-Lang Chen, Taoyuan County (TW); Wen-Chih Tai, Taoyuan County (TW); Shian-Jun Chiou, Taipei City (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/552,292

(22) Filed: Sep. 2, 2009

(30) Foreign Application Priority Data
May 19, 2009 (TW) 98116571

(51) Int. Cl. G09G 3/36

(52) U.S. Cl. 345/89

(57) ABSTRACT

An image processing device and a method thereof are provided. The image processing device includes a controller and an image processing unit. The controller generates a timing control signal according to an enabling signal. The image processing unit is coupled to the controller. The image processing unit receives a gray scale value of a pixel at a time and determines whether to change the gray scale value of the pixel at the time to a predetermined gray scale value according to the timing control signal. Thereby, the image quality is improved.

### CROSS-REFERENCE TO RELATED APPLICATION

This application claims the priority benefit of Taiwan application serial No. 98116571, filed on May 19, 2009. The entirety of the above-mentioned patent application is hereby incorporated by reference herein and made a part of this specification.

### BACKGROUND OF THE INVENTION

1. Field of the Invention

The present invention generally relates to an image processing technique, and more particularly, to an image processing technique of a liquid crystal display (LCD).

2. Description of Related Art

A liquid crystal display (LCD) can be categorized as a transmissive LCD, a reflective LCD, or a transflective LCD according to the position of its light source.

A transmissive LCD is illuminated by a light source disposed behind the liquid crystal panel, and a viewer has to view images displayed by the LCD from the front of the Liquid crystal panel. Transmissive LCDs are usually applied to devices that require high luminance display, such as computer displays, personal digital assistants (PDAs), and cell phones. The illumination device for illuminating a transmissive LCD usually consumes more power than the transmissive LCD itself.

Reflective LCDs are usually applied to electronic clocks and computers. A reflective LCD can receive an external light, wherein the external light passes through the liquid crystal panel to reach a dispersive reflective surface disposed behind the liquid crystal panel and then is reflected to the front of the liquid crystal panel by the reflective surface. Since a reflective LCD requires no illumination device, the power consumption thereof is reduced. However, because a reflective LCD has higher contrast and the light needs to pass the liquid crystal panel twice, the energy of the light is reduced twice and accordingly the image brightness is obviously reduced.

A transflective LCD can be served as a transmissive LCD or a reflective LCD. The transflective LCD is served as a reflective LCD when a backlight source thereof is turned off. In this case, the power consumption of the LCD is reduced, but the image brightness is also reduced. The transflective LCD is served as a transmissive LCD when the backlight source thereof is turned on. In this case, even though the image brightness is increased, the power consumption of the LCD is also increased.

### SUMMARY OF THE INVENTION

Accordingly, the present invention is directed to an image processing device and a method thereof so as to improve the image quality.

The present invention is directed to an image processing method. In the present image processing method, a gray scale value of a pixel at a first time is received, and whether to change the gray scale value of the pixel at the first time to a predetermined gray scale value is determined according to a timing.

According to an embodiment of the present invention, in the image processing method, a gray scale value of the pixel at a second time is further received, and whether to change the gray scale value of the pixel at the second time to the predetermined gray scale value is determined according to the timing.

According to an embodiment of the present invention, if the gray scale value of the pixel at the first time is to be changed to the predetermined gray scale value and the gray scale value of the pixel at the second time is not to be changed to the predetermined gray scale value, the gray scale value of the pixel at the second time is adjusted according to the gray scale value of the pixel at the first time.

The present invention provides an image processing method. In the present image processing method, a first sub image of an image is received, and a first block set of the first sub image is changed to a predetermined gray scale value according to a timing. In addition, a second sub image of the image is received, and a second block set of the second sub image is changed to the predetermined gray scale value according to the timing.

According to an embodiment of the present invention, in the image processing method, a third sub image of the image is further received, and a third block set of the third sub image is changed to the predetermined gray scale value according to the timing.

According to an embodiment of the present invention, in the image processing method, a third sub image of the image is further received, and a third block set of the third sub image is adjusted according to the first block set of the first sub image and the second block set of the second sub image.

According to an embodiment of the present invention, in the image processing method, a third block set of the first sub image is further adjusted according to the second block set of the second sub image. In addition, a fourth block set of the second sub image is adjusted according to the first block set of the first sub image.

The present invention also provides an image processing device including a controller and an image processing unit. The controller generates a timing control signal according to an enabling signal. The image processing unit is coupled to the controller. The image processing unit receives a gray scale value of a pixel at a first time and determines whether to change the gray scale value of the pixel at the first time to a predetermined gray scale value according to the timing control signal.

The present invention further provides an image processing device including a controller and an image processing unit. The controller generates a timing control signal according to an enabling signal. The image processing unit is coupled to the controller. The image processing unit receives a first sub image and a second sub image of an image and changes a first block set of the first sub image and a second block set of the second sub image to a predetermined gray scale value according to the timing control signal.

As described above, in the present invention, a gray scale value of a pixel at a time is received, and whether the gray scale value of the pixel at the time is changed to a predetermined gray scale value is determined according to a timing. Thereby, the image quality is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a transflective liquid crystal display (LCD) according to a first embodiment of the present invention.

FIG. 2 is a flowchart of an image processing method according to the first embodiment of the present invention.

FIG. 3 is a diagram of an image processing method according to the first embodiment of the present invention.

FIG. 4 is a flowchart of another image processing method according to the first embodiment of the present invention.

FIG. 5 is a diagram of an imaging processing method according to a second embodiment of the present invention.

FIGS. 6-9 are diagrams of an image processing method according to a third embodiment of the present invention.

FIG. 10A is a diagram of an unprocessed image according to a fourth embodiment of the present invention.

FIG. 10B is a diagram of a processed image according to the fourth embodiment of the present invention.

FIG. 11A is a diagram of an unprocessed image according to a fifth embodiment of the present invention.

FIG. 11B is a diagram of a processed image according to the fifth embodiment of the present invention.

FIG. 11C is a diagram of another processed image according to the fifth embodiment of the present invention.

FIG. 12 is a diagram of a transflective LCD according to a sixth embodiment of the present invention.

FIG. 13 is a diagram of a reflective LCD according to a seventh embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The image brightness of a conventional reflective liquid crystal display (LCD) is obviously reduced, and when a conventional transflective LCD is served as a reflective LCD, the image brightness thereof is also obviously reduced.

Accordingly, embodiments of the present invention provide an image processing technique to increase the image brightness of an LCD that works in a reflective manner. To be specific, in some embodiments of the present invention, the gray scale value of each block set of an image is periodically changed to a high-luminance gray scale value according to a timing, so that the main information in the image can be effectively preserved and the image brightness can be effectively increased.

In some embodiments of the present invention, the gray scale value of each block set of an image may also be alternatively and periodically changed to the high-luminance gray scale value according to the timing, so that the image uniformity can be effectively improved and image flickering can be avoided.

In some embodiments of the present invention, the original data of an image before the gray scale value of each block set of the image is changed to the high-luminance gray scale value may be preserved, and an image before or after the present image is compensated according to the original data, so that the main information in the image can be further preserved, and meanwhile, the image brightness can be effectively increased. Reference will now be made in detail to the present preferred embodiments of the invention, examples of which are illustrated in the accompanying drawings. Wherever possible, the same reference numbers are used in the drawings and the description to refer to the same or like parts.

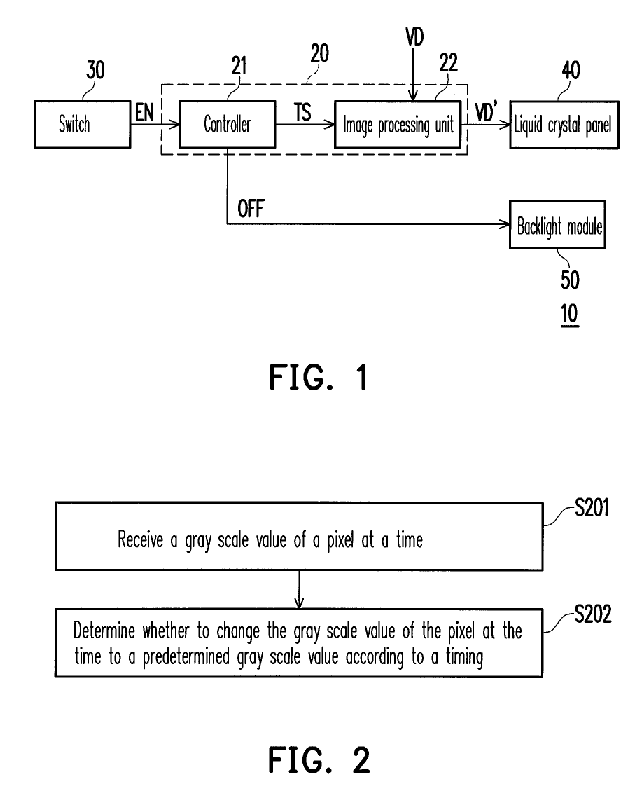

First, a transflective LCD is taken as an example. FIG. 1 is a diagram of a transflective LCD according to a first embodiment of the present invention. Referring to FIG. 1, the transflective LCD 10 includes an image processing device 20, a switch 30, a liquid crystal panel 40, and a backlight module 50. The image processing device 20 includes a controller 21 and an image processing unit 22.

In the present embodiment, the controller 21 is coupled to the switch 30, the backlight module 50, and the image processing unit 22. The image processing unit 22 is coupled to the liquid crystal panel 40. In the present embodiment, the switch 30 may be a button, and the switch 30 issues an enabling signal EN when it is pressed down, wherein the enabling signal EN indicates that the transflective LCD 10 is served as a reflective LCD. The controller 21 receives the enabling signal EN from the switch 30 and provides a turn-off signal OFF to the backlight module 50 according to the enabling signal EN to turn off the backlight module 50, so as to reduce the power consumption. The controller 21 also provides a timing control signal TS to the image processing unit 22 according to the enabling signal EN. The image processing unit 22 processes a video data VD according to the timing control signal TS, so as to provide an adjusted video data VD′ and increase the image brightness.

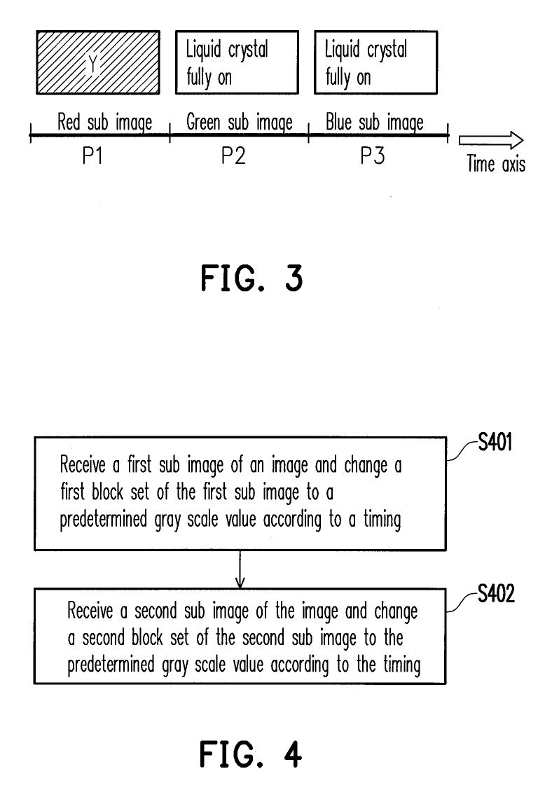

FIG. 2 is a flowchart of an image processing method according to the first embodiment of the present invention. FIG. 3 is a diagram of an image processing method according to the first embodiment of the present invention. Referring to FIGS. 1˜3, in the present embodiment, the transflective LCD 10 is assumed to be a color sequential display. To be specific, in the present embodiment, it is assumed that a color image is obtained by quickly switching a red image, a green image, and a blue image. Namely, a color image is composed of a red sub image, a green sub image, and a blue sub image.

When the transflective LCD 10 is served as a reflective LCD and accordingly the backlight module 50 is turned off, the transflective LCD 10 cannot present a color image. Accordingly, the gray scale value of each pixel in the red sub image, the green sub image, and the blue sub image of the color image cannot reflect a red gray scale value, a green gray scale value, or a blue gray scale value, and the red sub image, the green sub image, and the blue sub image are all considered sub images that can only present black/white gray scale values. Namely, when the gray scale values of the red sub image are the same as the gray scale values of the green sub image, the red sub image is actually the same as the green sub image.

Accordingly, in the image processing method provided by the present embodiment, first, in step S201, a gray scale value of each pixel of an image during each of the time periods P1, P2, and P3 on the time axis is received. Then, in step S202, whether to change the gray scale value of the pixel during the time period P1, P2, or P3 to a predetermined gray scale value is determined according to a timing. To be specific, the image processing unit 22 changes the gray scale value of each pixel in the green sub image and the blue sub image to a high-luminance gray scale value. Assuming the LCD is a normally white LCD and the gray scale value of each pixel falls between 0 and 255, the image processing unit 22 changes the gray scale value of each pixel in the green sub image and the blue sub image to 255, and which is referred to as fully on liquid crystal. When the liquid crystal panel 40 displays the green sub image and the blue sub image, the transmittance of the liquid crystal panel 40 is improved considerably, and accordingly, the image brightness is effectively increased.

On the other hand, in the present embodiment, the gray scale value of each pixel in the red sub image can be adjusted according to the gray scale value of each pixel in the green sub image and the blue sub image. For example, assuming the initial gray scale value of each pixel in the red sub image is R0, the initial gray scale value of each pixel in the green sub image is G0, the initial gray scale value of each pixel in the blue sub image is B0, and the gray scale value of each pixel in the adjusted red sub image is Y, in the present embodiment, Y=(R0+G0+B0)/3. However, the present invention is not limited thereto, and those skilled in the art may obtain Y according to the actual requirement. For example, in other embodiments of the present invention, there may be Y=(R0+2G0+B0)/4 or Y=(2R0+3G0+2B0)/7, etc. Accordingly, the gray scale values of pixels in the green sub image and the blue sub image are effectively preserved. It should be noted that when the backlight module 50 is turned off, the transflective LCD 10 cannot present a color image (i.e., can only present black/white gray scale images). Thus, no color error will be produced by adjusting the gray scale values of the pixels in the red sub image.

FIG. 4 is a flowchart of another image processing method according to the first embodiment of the present invention. Referring to FIG. 1, FIG. 3, and FIG. 4, in the present embodiment, whether to change each block set in each sub image to a predetermined gray scale value is respectively determined according to a timing. First, in step S401, a plurality of sub images of an image is received. Then, in step S402, whether to change each block set in each of the sub images to a predetermined gray scale value is respectively determined according to a timing. To be specific, a red sub image, a green sub image, and a blue sub image are received (step S401). Then, the gray scale values of the full block sets in the green sub image and the blue sub image are changed to 255 according to the timing (step S402). However, the present invention is not limited thereto, and in another embodiment of the present invention, step S402 may also be respectively determining whether to change a partial block set in each of the sub images to the predetermined gray scale value according to the timing.

In addition, it may also be adjusting the gray scale value of each pixel in the red sub image according to the gray scale value of each pixel in the green sub image and the blue sub image to obtain the adjusted red sub image Y. The same effect can be achieved through this method.

It should be mentioned that even though a possible pattern of the image processing device and method thereof has been described in foregoing embodiment, those having ordinary knowledge in the art should understand that different manufacturers have different designs in the image processing device and the method thereof, and accordingly the application of the present invention should not be limited to this possible pattern. In other words, it is within the spirit of the present invention as long as a gray scale value of each pixel at a time is received and whether the gray scale value of the pixel at the time is changed to a predetermined gray scale value is determined according to a timing. Some other embodiments of the present invention will be described below so that those having ordinary knowledge in the art can further understand the spirit of the present invention and implement the present invention according to the present disclosure.

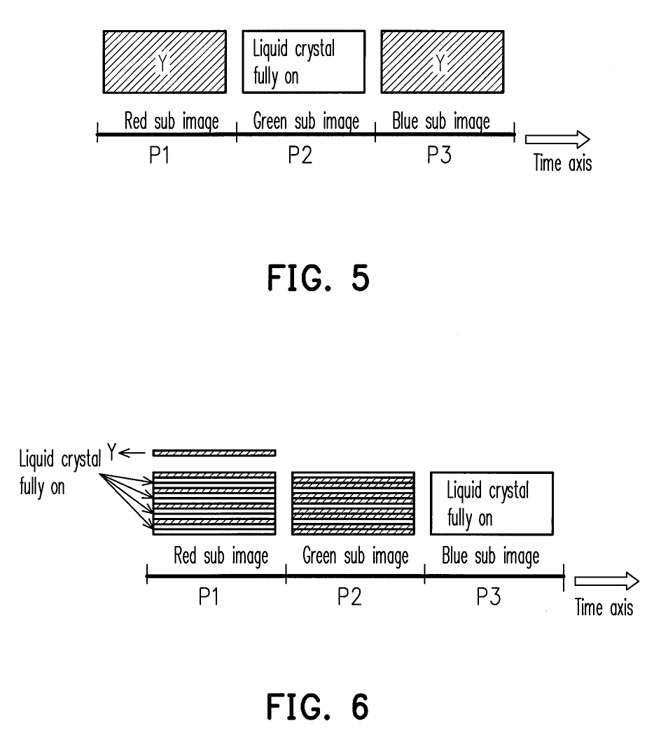

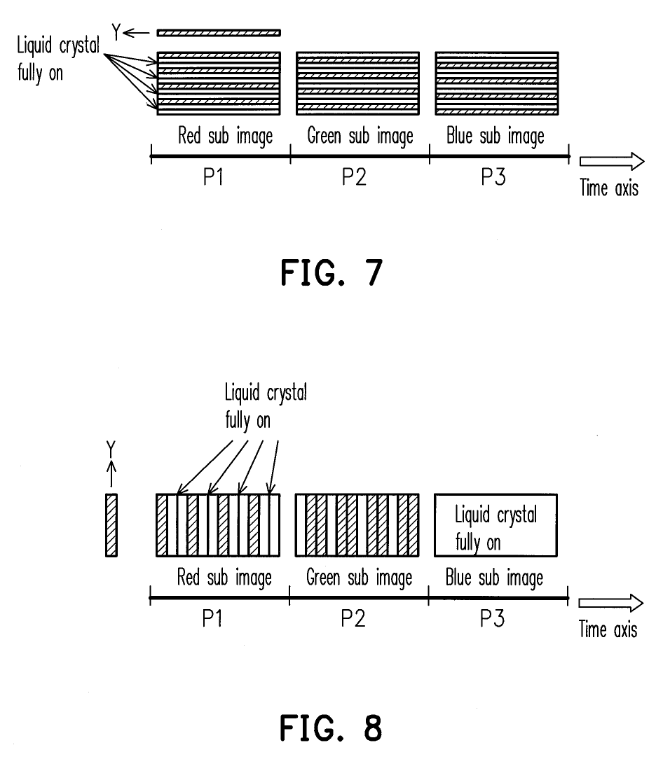

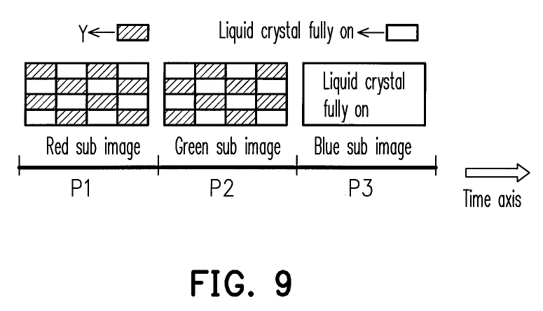

The present invention is not limited to the first embodiment illustrated in FIG. 3. FIG. 5 is a diagram of an imaging processing method according to a second embodiment of the present invention. In the present embodiment, the image brightness is increased by changing the gray scale value of each pixel in only the green sub image to the predetermined gray scale value. In addition, the red sub image and the blue sub image are adjusted according to the red sub image, the green sub image, and the blue sub image so that more original image information is preserved and the image quality is improved.

Moreover, those skilled in the art may also distribute the adjusted red sub image Y in the first embodiment into multiple sub images to be displayed according to the actual requirement. FIGS. 6˜9 are diagrams of an image processing method according to a third embodiment of the present invention. Accordingly, besides achieving the same effect as in the first embodiment, the image uniformity can be improved, and image flickering can be avoided.

In the first embodiment, the transflective LCD 10 scans an image in the sequence of the red, the green, and the blue sub image. However, the present invention is not limited thereto. For example, in other embodiments of the present invention, the transflective LCD 10 may also scan an image in the sequence of the red, the red, the green, the green, the blue, and the blue sub image, or in the sequence of the red, the green, the blue, and the white sub image, or in the sequence of the red, the green, the blue, and the green sub image. Namely, the image processing technique described above can be applied to LCDs having different scanning patterns.

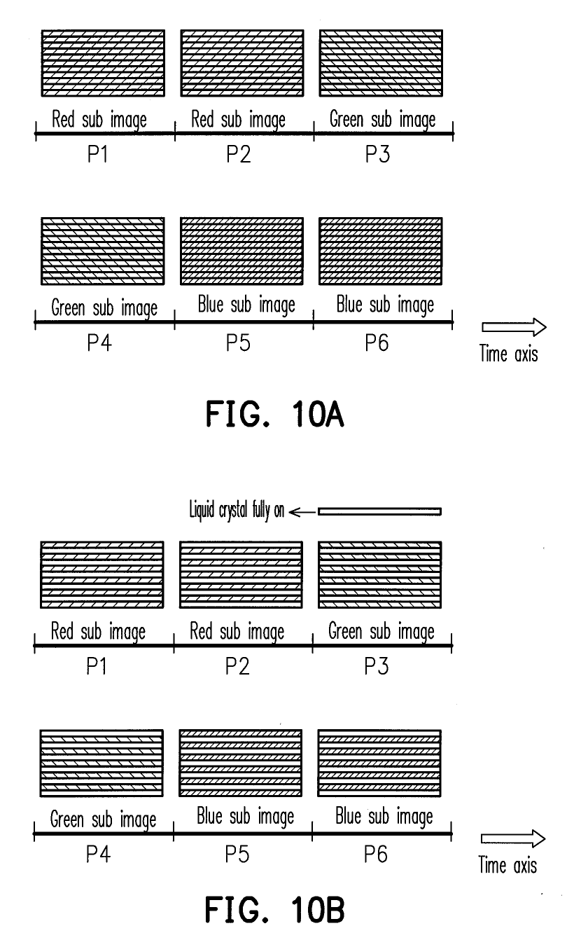

FIG. 10A is a diagram of an unprocessed image according to a fourth embodiment of the present invention. Referring to FIG. 10A, in the present embodiment, it is assumed that the LCD scans an image in the sequence of the red, the red, the green, the green, the blue, and the blue sub image. The image illustrated in FIG. 10A can be processed according to the present invention as described above. FIG. 10B is a diagram of a processed image according to the fourth embodiment of the present invention. Referring to both FIG. 10A and 10B, in the present embodiment, during the time period P1, the gray scale values of the pixels in the even rows of the red sub image are changed to a predetermined gray scale value according to a timing. In addition, during the time period P2, the gray scale values of the pixels in the odd rows of the red sub image are changed to the predetermined gray scale value according to the timing. The image processing processes during the time periods P3˜P6 are carried out similarly.

It should be noted that in the present embodiment, some blocks in the sub images during each time period are changed to the predetermined gray scale value so that the image brightness can be effectively increased. On the other hand, the image information of some blocks of the sub images during each time period is alternatively preserved so that a clear image can be displayed.

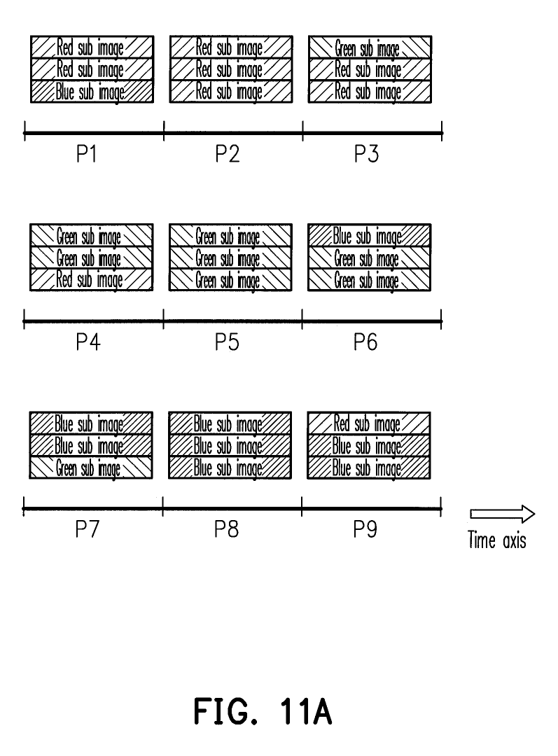

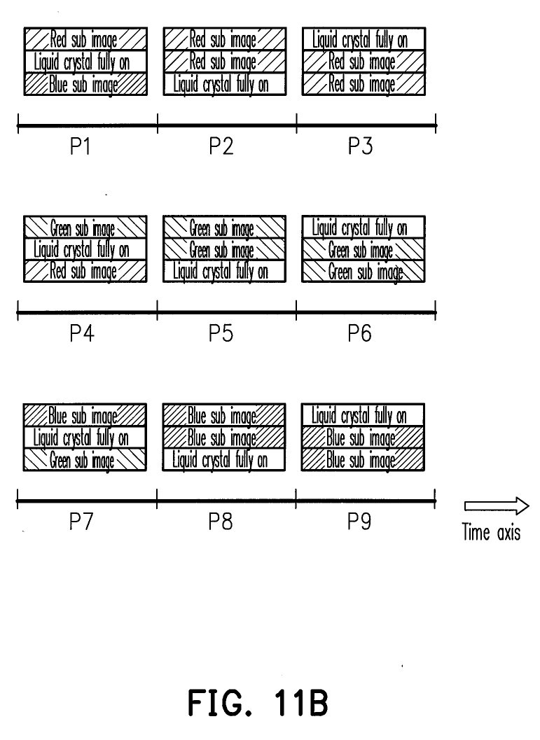

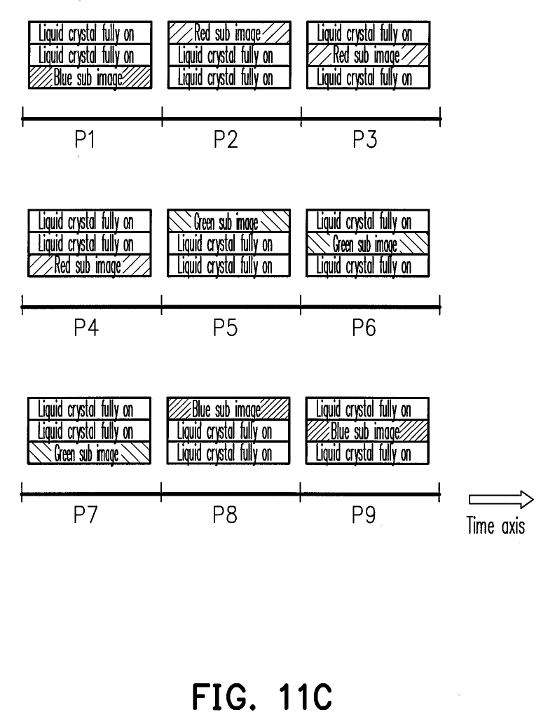

FIG. 11A is a diagram of an unprocessed image according to a fifth embodiment of the present invention. Referring to FIG. 11A, in the present embodiment, it is assumed that each image is divided into three blocks, wherein the upper block is scanned in the sequence of red, red, green, green, green, blue, blue, blue, and red sub images. The middle block is scanned in the sequence of red, red, red, green, green, green, blue, blue, and blue sub images, and the lower block is scanned in the sequence of blue, red, red, red, green, green, green, blue, and blue sub images.

The image illustrated in FIG. 11A can be processed according to the present invention as described above. FIG. 11B is a diagram of a processed image according to the fifth embodiment of the present invention. Referring to both FIG. 11A and FIG. 11B, in the present embodiment, during the time periods P1, P4, and P7, the gray scale values of the pixels in the middle block are changed to the predetermined gray scale value according to a timing. Besides, during the time periods P2, P5, and P8, the gray scale values of the pixels in the lower block are changed to the predetermined gray scale value according to the timing, and during the time periods P3, P6, and P9, the gray scale values of the pixels in the upper block are changed to the predetermined gray scale values according to the timing. Through this method, the same effect as that described in foregoing embodiments can be achieved.

FIG. 11C is a diagram of another processed image according to the fifth embodiment of the present invention. Referring to both FIG. 11A and FIG. 11C, in the present embodiment, during the time periods P1, P4, and P7, the gray scale values of the pixels in the middle block are changed to the predetermined gray scale value according to the timing. Besides, during the time periods P2, P5, and P8, the gray scale values of the pixels in the lower block are changed to the predetermined gray scale value according to the timing, and during the time periods P3, P6, and P9, the gray scale values of the pixels in the upper block are changed to the predetermined gray scale value according to the timing. Through this method, the same effect as described in foregoing embodiments can be achieved.

Additionally, in the first embodiment, the LCD structure illustrated in FIG. 1 is only an embodiment of the present invention but not for limiting the present invention, and those skilled in the art should be able to alter the LCD structure according to the actual requirement. For example, the switch 30 in FIG. 1 may also be replaced by a control unit, and the enabling signal EN may also be generated by the control unit.

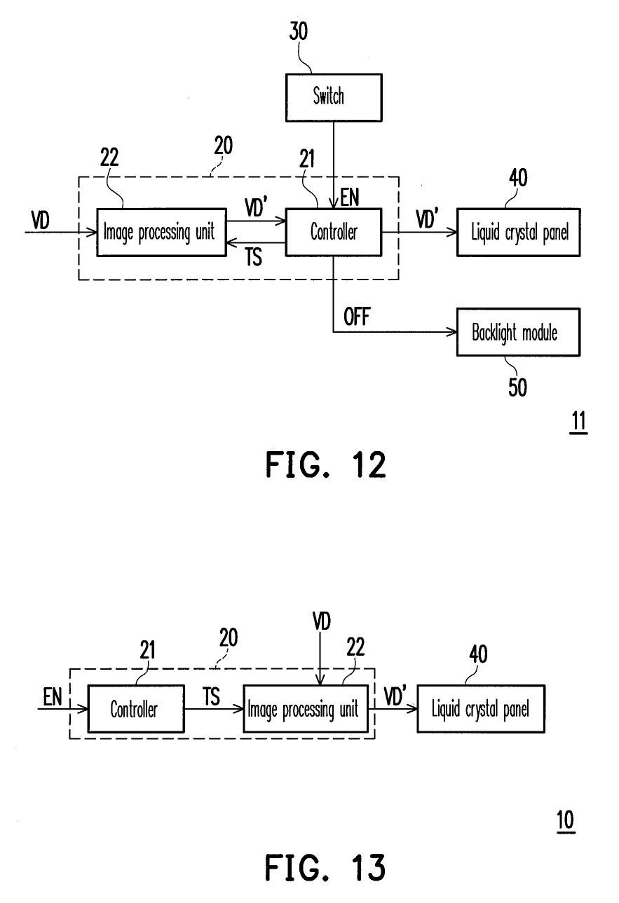

FIG. 12 is a diagram of a transflective LCD according to a sixth embodiment of the present invention. Referring to both FIG. 1 and FIG. 12, the transflective LCD 11 in FIG. 12 is similar to the transflective LCD 10 in FIG. 1 and offers the same function, and the difference between the two falls on the disposed positions of the image processing unit 22 and the controller 21.

In addition, even though the LCD in the first embodiment is described with a transflective LCD as an example, the present invention is not limited thereto. The present invention may also be applied to a reflective LCD. FIG. 13 is a diagram of a reflective LCD according to a seventh embodiment of the present invention. In the present embodiment, the image processing method described above is also implemented in the image processing device 20 of the reflective LCD 13 to achieve the similar function.

Even though the LCD is described with a normally white LCD as an example in the first embodiment, the present invention is not limited thereto, and the present invention may also be applied to a normally black LCD.

As described above, in the present invention, a gray scale value of a pixel at a time is received, and whether to change the gray scale value of the pixel at the time to a predetermined gray scale value is determined according to a timing. Thereby, the image quality is improved. In addition, embodiments of the present invention further achieve following effects:
1. periodically changing the gray scale value of each block set in an image to a high-luminance gray scale value, so that the main information of the image can be effectively preserved and the image brightness can be effectively increased.
2. alternatively and periodically changing the gray scale value of each block set in the image to a high-luminance gray scale value, so that not only the main information of the image can be effectively preserved and the image brightness can be effectively increased, the uniformity of the image can also be effectively improved and image flickering can be avoided.
3. preserving the original data of an image before the gray scale value of each block set in the image is changed to a high-luminance gray scale value, and compensating the image before or after the present image according to the original data, so that the main information of the image can be further preserved, and the image brightness can be effectively increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processing method, comprising:
receiving a gray scale value of a pixel at a first time; and
determining whether to change the gray scale value of the pixel at the first time to a predetermined gray scale value according to a timing.

2. The image processing method according to claim 1 further comprising:
receiving a gray scale value of the pixel at a second time; and
determining whether to change the gray scale value of the pixel at the second time to the predetermined gray scale value according to the timing.

3. The image processing method according to claim 2 further comprising:
if the gray scale value of the pixel at the first time is to be changed to the predetermined gray scale value and the gray scale value of the pixel at the second time is not to be changed to the predetermined gray scale value, adjusting the gray scale value of the pixel at the second time according to the gray scale value of the pixel at the first time.

4. An image processing method, comprising:
receiving a first sub image of an image;
changing a first block set of the first sub image to a predetermined gray scale value according to a timing;
receiving a second sub image of the image; and
changing a second block set of the second sub image to the predetermined gray scale value according to the timing.

5. The image processing method according to claim 4 further comprising:
receiving a third sub image of the image, and changing a third block set of the third sub image to the predetermined gray scale value according to the timing.

6. The image processing method according to claim 4 further comprising:
receiving a third sub image of the image, and adjusting a third block set of the third sub image according to the first block set of the first sub image and the second block set of the second sub image.

7. The image processing method according to claim 4 further comprising:
adjusting a third block set of the first sub image according to the second block set of the second sub image.

8. The image processing method according to claim 7 further comprising:
adjusting a fourth block set of the second sub image according to the first block set of the first sub image.

9. An image processing device, comprising:
a controller, for generating a timing control signal according to a enabling signal; and
an image processing unit, coupled to the controller, for receiving a gray scale value of a pixel at a first time and determining whether to change the gray scale value of the pixel at the first time to a predetermined gray scale value according to the timing control signal.

10. The image processing device according to claim 9, wherein the image processing unit further receives a gray scale value of the pixel at a second time and determines whether to change the gray scale value of the pixel at the second time to the predetermined gray scale value according to the timing control signal.

11. The image processing device according to claim 9, wherein if the gray scale value of the pixel at the first time is to be changed to the predetermined gray scale value and the gray scale value of the pixel at the second time is not to be changed to the predetermined gray scale value, the image processing unit adjusts the gray scale value of the pixel at the second time according to the gray scale value of the pixel at the first time.

12. An image processing device, comprising:
a controller, for generating a timing control signal according to an enabling signal; and
an image processing unit, coupled to the controller, for receiving a first sub image and a second sub image of an image and changing a first block set of the first sub image and a second block set of the second sub image to a predetermined gray scale value according to the timing control signal.

13. The image processing device according to claim 12, wherein the image processing unit further receives a third sub image of the image and changes a third block set of the third sub image to the predetermined gray scale value according to the timing control signal.

14. The image processing device according to claim 12, wherein the image processing unit further receives a third sub image of the image and adjusts a third block set of the third sub image according to the first block set of the first sub image and the second block set of the second sub image.

15. The image processing device according to claim 12, wherein the image processing unit further adjusts a third block set of the first sub image according to the second block set of the second sub image.

16. The image processing device according to claim 15, wherein the image processing unit further adjusts a fourth block set of the second sub image according to the first block set of the first sub image.
